(19) United States
(12) Patent Application Publication
(10) Pub. No.: US 2009/0239511 A1
(43) Pub. Date: Sep. 24, 2009

(54) LOCATION BASED SERVICE SYSTEM FOR ADVERTISEMENT DATA

(76) Inventors: Po-Ju CHEN, Taipei (TW); Wen-Hung Hsu, Taipei (TW); Hsin-Hsin Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/108,688

(22) Filed: Apr. 24, 2008

(30) Foreign Application Priority Data
Mar. 19, 2008 (TW) 097204709

(51) Int. Cl. H04M 3/42

(52) U.S. Cl. 455/414.1

(57) ABSTRACT

A sends and receives advertisement data through wireless LAN. The location based service system includes a plurality of commercial store base stations and at least one client end apparatus operatively connected to the commercial store base stations through the wireless LAN. Therefore, consumer can know the commodity information of the commercial store when he is within an accessible region of the commercial store base station. Moreover, the consumer can know desired commodity information and geographic location of the store with client end apparatus thereof.

### BACKGROUND OF THE INVENTION

1. Field of the Invention

The present invention relates to a location based system for advertisement data, especially to a location based service system sending and receiving advertisement data through wireless LAN.

2. Description of Prior Art

Advertisement is useful to attract potential consumer for purchasing commodity or service, or for non-profit usage. Moreover, advertisement has notification utility to enhance brand value.

The conventional advertisement may appear on newspaper, magazine, television, movie, film slide, package envelope, poster, POP media, traffic sign or direct mail. The propaganda way for advertisement may be more diverse as new medium is developed.

However, above-mentioned conventional advertisement medium lacks the ability of providing instant advertisement information for nearby consumer. The advertisement information can be valuable information such as commodity under sale, special-priced commodity and location of the store.

### SUMMARY OF THE INVENTION

It is the object of the present invention to provide a location based service system, through which commercial store can send and receive advertisement data through wireless network and the base station set by the commercial store. Therefore, consumer can know the commodity information of the commercial store when he is within an accessible region of the commercial store base station. Moreover, the consumer can know desired commodity information with client end apparatus thereof.

Accordingly, the present invention provides a location based service system for sending and receiving advertisement data. The location based service system comprises a plurality of commercial store base stations and at least one client end apparatus operatively connected to the commercial store base stations through a wireless network. Each of the commercial store base stations comprises a first advertisement processing device and a base station protocol device electrically connected to the first advertisement processing device; wherein the first advertisement processing device is configured to receive and process the advertisement data, and the base station protocol device is configured to send the advertisement data and a geographic data for the commercial store base station. The client end apparatus comprises a second advertisement processing device and a client end protocol device electrically connected to the second advertisement processing device. The client end protocol device is configured to receive the advertisement data and the geographic data send from for the commercial store base stations. The second advertisement processing device is configured to display the advertisement data and a location corresponding to the geographic data.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of the commercial store base station according to the present invention

FIG. 2 shows a block diagram of a client end apparatus.

FIG. 3 is a schematic view showing the connection of the client end apparatus and the commercial store base station through a wireless LAN.

FIGS. 4A-4C demonstrates a base station group constituted of three commercial store base stations.

### DETAILED DESCRIPTION OF THE INVENTION

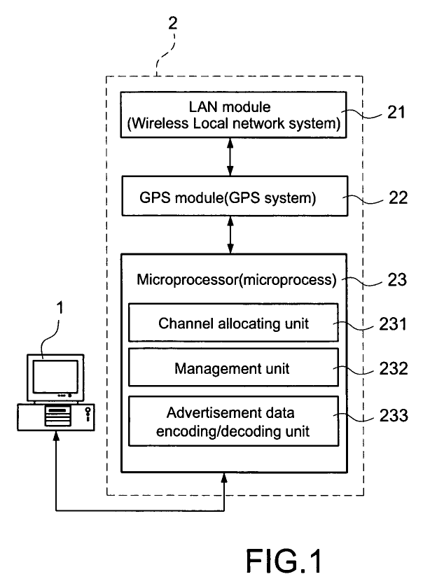

FIG. 1 shows the block diagram of the commercial store base station according to the present invention, wherein the commercial store base station comprises a first advertisement processing device 1 and a base station protocol device 2.

The first advertisement processing device 1 stores advertisement data for the commercial store per se, or stores advertisement data sent from adjacent commercial store(s). The first advertisement processing device 1 can be at least one of desktop computer, laptop computer, server system, data processing system, portable device, mobile phone, personal communication system and Personal Digital Assistant (PDA).

The base station protocol device 2 is electrically connected to the first advertisement processing device 1. The base station protocol device 2 receives advertisement data sent from the first advertisement processing device 1, and then sends the advertisement data to client end (user end). The base station protocol device 2 also receives advertisement data sent from adjacent commercial store and then sends the advertisement data to the first advertisement processing device 1 for further process and storage. The first advertisement processing device 1 then sends the advertisement data to client end through the base station protocol device 2. The base station protocol device 2 comprises a wireless LAN (local area network) module 21, a GPS module 22 and a microprocessor 23.

The wireless LAN module 21 is operatively connected to a wireless LAN (not shown) and communicates with client end through the wireless LAN. The wireless LAN module 21 sends the advertisement data sent from commercial store, and links with the base station of other commercial stores.

The GPS module 22 receives a GPS signal for positioning the base station of corresponding commercial stores.

The microprocessor 23 comprises a channel allocating unit 231, a management unit 232 for base station group and an advertisement data encoding/decoding unit 233.

The channel allocating unit 231 compares ID value for each base station after a plurality of base stations have been set up, wherein the base station with the smallest ID value can be assigned as the host base station to allocate channel used by all the base stations. Alternatively, the base station with the largest ID value can be assigned as the host base station to allocate channel used by all the base stations.

The management unit 232 for base station group establishes the base station group for base stations in a neighbor region and manages the communication among the base stations when a plurality of adjacent base stations is present.

The advertisement data encoding/decoding unit 233 decodes the advertisement data sent from the first advertisement processing device 1 and then encodes the data according to desired format of the wireless LAN module 21. The advertisement data coding/decoding unit 233 then sends the encoded data to the wireless LAN. The portable device at client end can display all advertisement data sent from all stores after the wireless LAN module at client end receives the advertisement data.

The commercial store base stations are positioned through the management unit 232 for base station group and the GPS module 22; and then the ID values of all commercial store base station are compared by the microprocessor 23. The base station with the smallest ID value can be assigned as host base station, which has the ability to allocate channel used by all base stations. Alternatively, the base station with the largest ID value can be assigned as host base station to allocate channel used by the base stations. The channel allocating unit 231 sends the allocated channels and time slots to each commercial store base station. The commercial store base stations sends data thereof in allocated channels and time slots, and exchanges data with neighbor commercial store base stations in allocated channels and time slots. When a commercial store base station has interference problem in allocated channel and time slot, the channel allocating unit 231 of the host base station sends another allocated channel and time slot to the commercial store base station with interference problem. The host base station can search new commercial store base station by switching its channel to a public channel, and can check whether any base station in the base station group has updated advertisement data.

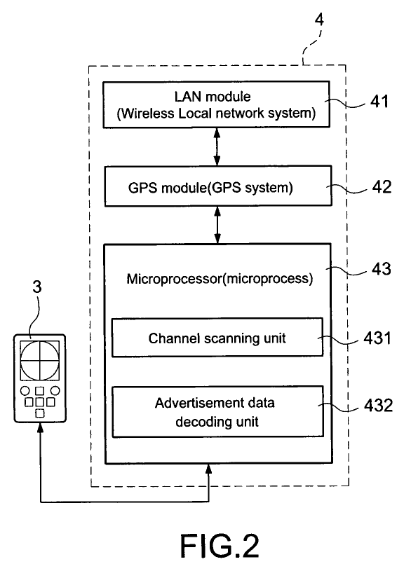

FIG. 2 shows a block diagram of a client end apparatus, which comprises a second advertisement processing device 3 and a client end protocol device 4.

The second advertisement processing device 3 displays the advertisement data received by the client end protocol device 4. The second advertisement processing device 3 can be at least one of desktop computer, laptop computer, server system, data processing system, portable device, mobile phone, personal communication system and Personal Digital Assistant (PDA).

The client end protocol device 4 is electrically connected to the second advertisement processing device 3. The client end protocol device 4 receives advertisement data provided by neighbor commercial store base station after the client end protocol device 4 scans channels and time slots.

The client end protocol device 4 comprises a wireless LAN module 41, a GPS module 42 and a microprocessor 43.

The wireless LAN module 41 is operatively connected to the wireless LAN (not shown) to receive advertisement data provided by neighbor commercial store base station.

The GPS module 42 receives a GPS signal for positioning the location of user (client) and calculates a distance between the user and a target commercial store.

The microprocessor 43 comprises a channel scanning unit 431 and an advertisement data decoding unit 432. The channel scanning unit 431 switches a reception frequency to one of commercial channels in order to receive advertisement data provided by neighbor commercial store base station.

The advertisement data decoding unit 432 decodes the advertisement data provided by neighbor commercial store base station and sends the decoded data to the second advertisement processing device 3 for display.

In the application of the client end apparatus, the GPS module 42 first finds the position of the client end apparatus. The channel scanning unit 431 switches its reception channel and time slots to possible channel and time slots of the neighbor commercial store base station to receive advertisement data. The received advertisement data is displayed on the second advertisement processing device 3.

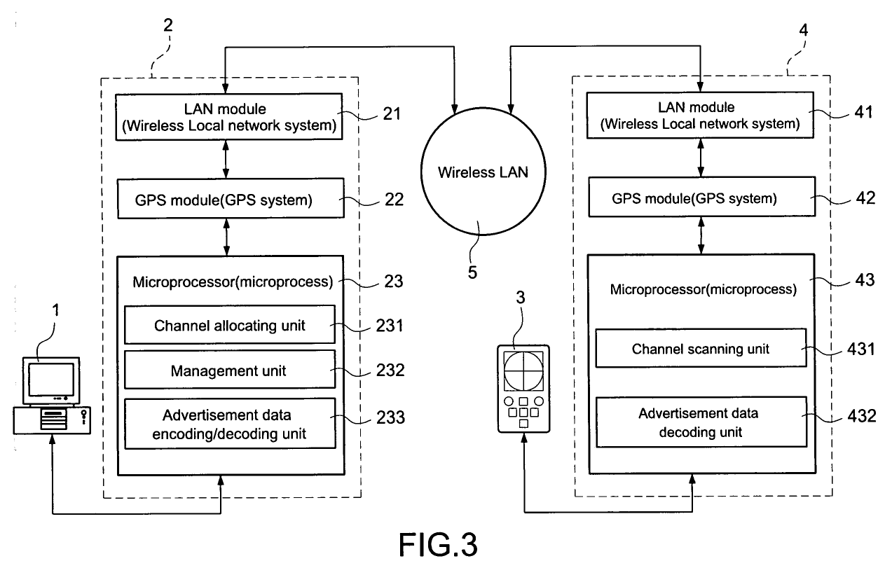

FIG. 3 is a schematic view showing the connection of the client end apparatus and the commercial store base station through a wireless LAN 5. After the wireless LAN module 41 accesses the wireless LAN 5, the first advertisement processing device 1 sends advertisement data to the base station protocol device 2. The advertisement data encoding/decoding unit 233 processes the advertisement data and then the processed advertisement data together with the geometric location of the commercial store are sent through the GPS module 22 and the wireless LAN module 21. The processed advertisement data and the geometric location of the commercial store are transmitted through the wireless LAN 5 and received by the wireless LAN module 4 at user end. Therefore user can know the advertisement data and the geometric location of the commercial store. When user wants to purchase commodities provided by the commercial store, the user can find the geometric location of the commercial store provided by the GPS module 42 thereof.

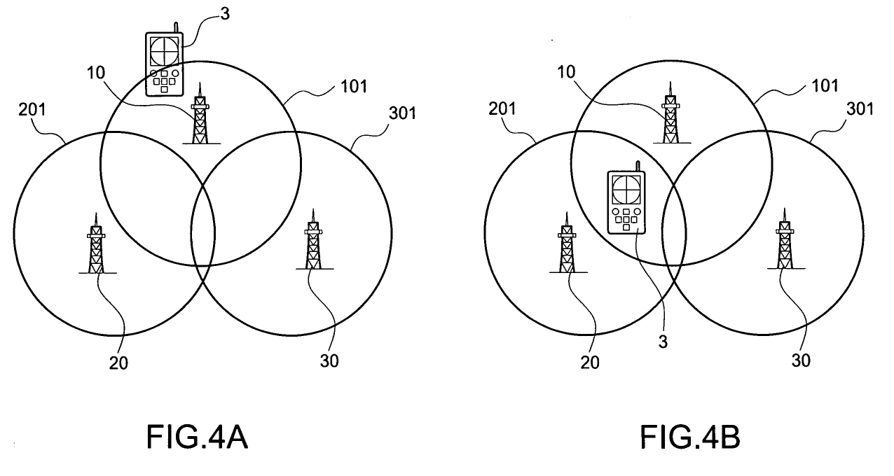

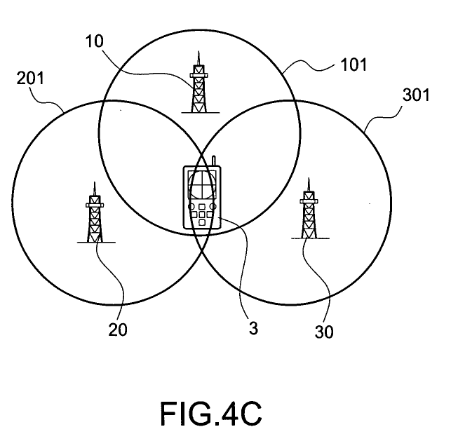

FIGS. 4A-4C demonstrates a base station group constituted of three commercial store base stations, namely a first base station 10, a second base station 20 and a third base station 30. The three base stations compare the ID values for each other. According to one scenario, the first base station 10 is the host base station to allocate channel and time slot for each base station if the first base station 10 has the smallest ID value. As shown in FIGS. 4A-4C, a circle 101 indicates the accessible boundary of the first base station 10 for sending advertisement data. Similarly, circles 201 and 301 respectively indicate the accessible boundaries of the base stations 20 and 30 for sending advertisement data.

When a user with the advertisement processing device 3 is located within the circle 101 only, the advertisement processing device 3 can only receive advertisement data from the first base station 10. When a user with the advertisement processing device 3 is located within an overlapped region of the circle 101 and the circle 201, the advertisement processing device 3 can receive advertisement data from both the first base station 10 and the second base station 20. When a user with the advertisement processing device 3 is located within an overlapped region of the circles 101, 201 and 301, the advertisement processing device 3 can receive advertisement data from the first base station 10, the second base station 20, and the third base station 30. The advertisement data helps the user to find interested commodity and location of the store.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A location based service system sending and receiving advertisement data through wireless network, comprising:
a plurality of commercial store base stations; and
at least one client end apparatus operatively connected to the commercial store base stations through the wireless network,
each of the commercial store base stations comprising a first advertisement processing device and a base station protocol device electrically connected to the first advertisement processing device; wherein the first advertisement processing device is configured to receive and process the advertisement data, and the base station protocol device is configured to send the advertisement data and a geographic data for the commercial store base station,
wherein the client end apparatus comprises a second advertisement processing device and a client end protocol device electrically connected to the second advertisement processing device,
wherein the client end protocol device is configured to receive the advertisement data and the geographic data send from for the commercial store base stations; and the second advertisement processing device is configured to display the advertisement data and a location corresponding to the geographic data.

2. The system in claim 1, wherein the first advertisement processing device is one of desktop computer, laptop computer, server system, data processing system, portable device, mobile phone, personal communication system and personal digital assistant (PDA).

3. The system in claim 1, wherein the base station protocol device comprises a wireless LAN (local area network) module, a GPS module and a microprocessor.

4. The system in claim 3, wherein the wireless LAN module is operatively connected to the client end apparatus through the wireless network to send advertisement data and communicate with other commercial store base stations.

5. The system in claim 3, wherein the GPS module is configured to receive a GPS signal and inform a location of the commercial store base station.

6. The system in claim 3, wherein the microprocessor comprises a channel allocating unit, a management unit for base station group and an advertisement data encoding/decoding unit.

7. The system in claim 6, wherein the channel allocating unit is configured to compare ID values associated with the plurality of commercial store base stations, wherein the commercial store base station with a smallest ID value is a host base station to allocate frequency channels for the commercial store base stations.

8. The system in claim 6, wherein the management unit for base station group is configured to set up a base station group for a plurality of commercial store base stations.

9. The system in claim 6, wherein the advertisement data encoding/decoding unit is configured to receive and decode an advertisement data from the first advertisement processing device, and then encode the advertisement data according to required data format of the wireless LAN module, and then send the advertisement data according to the wireless network.

10. The system in claim 1, wherein the client end protocol device comprises a wireless LAN module, a GPS module and a microprocessor.

11. The system in claim 10, wherein the wireless LAN module is operatively connected to the wireless network to receive advertisement data sent from the commercial store base stations.

12. The system in claim 10, wherein the GPS module is configured to receive a GPS signal and inform a location of the second advertisement processing device.

13. The system in claim 10, wherein the microprocessor comprises a channel scanning unit and an advertisement data decoding unit.

14. The system in claim 13, wherein the channel scanning unit is configured to switch a reception frequency to one of frequency channels of the commercial store base stations in order to receive advertisement data provided by neighbor commercial store base stations.

15. The system in claim 13, wherein the advertisement data decoding unit is configured to decode advertisement data provided by neighbor commercial store base station and to send the decoded data to the second advertisement processing device for display.

16. The system in claim 1, wherein the second advertisement processing device is one of desktop computer, laptop computer, server system, data processing system, portable device, mobile phone, personal communication system and personal digital assistant (PDA).

17. The system in claim 1, wherein the plurality of commercial store base stations are operatively connected through the wireless network to form a base station group.
